(19) United States
(12) Patent Application Publication
(10) Pub. No.: US 2015/0253629 A1
(43) Pub. Date: Sep. 10, 2015

(54) LIQUID CRYSTAL DISPLAY DEVICE AND METHOD FOR FABRICATING THE SAME

(71) Applicant: Mitsubishi Electric Corporation, Tokyo (JP)

(72) Inventor: Kazushi KIYOTA, Kumamoto (JP)

(73) Assignee: MITSUBISHI ELECTRIC CORPORATION, Tokyo (JP)

(21) Appl. No.: 14/635,512

(22) Filed: Mar. 2, 2015

(30) Foreign Application Priority Data
Mar. 4, 2014 (JP) 2014-041585

(51) Int. Cl. G02F 1/1337

(52) U.S. Cl. CPC G02F 1/133711; G02F 1/13378

(57) ABSTRACT

A liquid crystal display device according to the present invention is a liquid crystal display device including a substrate, and an alignment film on the substrate. The alignment film includes a first layer on the substrate, and a second layer on the first layer. The first layer has a higher amount of crosslinking agent added than that of the second layer.

### BACKGROUND OF THE INVENTION

1. Field of the Invention

The present invention relates to alignment films in liquid crystal display devices.

2. Description of the Background Art

As methods for forming thin films such as alignment films and color filters on glass substrates for use in liquid crystal display elements, there have been known printing methods using flexo printing devices. In such printing methods, a liquid-type thin-film formation material solution is dropped into the space between a doctor blade and an anilox roll (which is also referred to as an A roll), further, the thin-film formation material solution transferred to the outer peripheral surface of the anilox roll is transferred to a printing plate on a plate cylinder, the thin-film formation material solution transferred to the printing plate is transferred (printed) to the upper surface of a glass substrate to be applied thereto, and the thin-film formation material solution applied onto the glass substrate is heated to be cured, so that a thin film is formed on the glass substrate.

A rubbing process is performed on the surface of the thin film in order to provide an alignment control ability (an ability to secure the liquid crystal in certain directions) to the thin film. Such a rubbing process refers to a process of rubbing the thin film with a rubbing cloth, which is a cloth material provided with fine fibers. Further, providing the alignment control ability thereto is referred to as an aligning process, in general.

If the rubbing process is insufficient, this may degrade the alignment control ability, thereby inducing AC burn-in malfunctions (after-image phenomena which may be induced in AC-voltage driving states). Further, if the rubbing process is excessively performed, namely if a pressure more than necessary is applied thereto, this may induce exfoliation or scrapes of the thin film, thereby inducing fine bright spot defects.

On the other hand, in forming such conventional thin films, if the crosslinking agent concentration in the liquid-type thin-film formation material solution is increased, this inhibits exfoliation and scrapes of the thin film (hereinafter, in the present specification, the anti-exfoliation property and the anti-scrape property of the thin film will be comprehensively referred to as scrape resistance). As a result thereof, fine bright spot defects are decreased. However, the alignment control ability is degraded, thereby exacerbating the AC burn-in characteristic. In contrast, if the crosslinking agent concentration is decreased, this degrades the scrape resistance, which results in an increase of fine bright spot defects, while enhancing the alignment control ability, thereby improving the AC burn-in characteristic. Namely, there is a trade-off relationship between the enhancement of the scrape resistance and the enhancement of the alignment control ability with respect to the crosslinking agent concentration, which makes it difficult to design the film composition balance in such a way as to satisfy both the properties.

In particular, with liquid crystal panels of fringe field switching (FFS) types, which have been increasingly becoming mainstream recently, it is possible to achieve wider view angles, higher brightness and lower power consumption. However, such liquid crystal panels of FFS types are required to have higher alignment control abilities for providing higher display qualities and, further, are liable to induce AC burn-in, in comparison with liquid crystal panels of the TN (Twisted Nematic) mode, which have been conventionally ordinary types of liquid crystal panels. This makes it more difficult to design the balance in the alignment films.

Japanese Patent Application Laid-Open No. 10-111514 (1998) discloses a method which employs a solution containing two types of polyimide precursor resins, for liquid crystal panels having both enhanced scrape resistance and an enhanced alignment control ability. Namely, a polyimide precursor and/or a polyimide resin film is formed as a lower layer, and a soluble polyimide resin film is formed as an upper layer, thereby forming a liquid crystal alignment film having an excellent uniaxial alignment property and an excellent adhesion property to substrates. Further, although in conventional alignment films, crosslinking agents such as epoxy compounds are added in some cases for the sake of enhancing the mechanical strength, which leads to degradation of the liquid crystal alignment ability, Japanese Patent Application Laid-Open No. 2012-068612 discloses an alignment film characterized to exhibit both an excellent liquid crystal alignment ability and an excellent voltage holding property, by providing a contrivance to an organic resin constituent such as an aligning agent which composes the alignment film.

However, with the structure in Japanese Patent Application Laid-Open No. 10-111514 (1998), the solution containing the two types of polyimide precursor resins exhibits a smaller degree of layer separation during firing and, therefore, it is impossible to provide effective characteristics in the case of higher degree of separation between the lower layer and the upper layer. Further, with the structure in Japanese Patent Application Laid-Open No. 2012-068612, importance is placed on the liquid crystal alignment control ability and, as a result thereof, it is impossible to provide sufficient characteristics regarding the scrape resistance which is in a trade-off relationship with the alignment control ability.

### SUMMARY OF THE INVENTION

It is an object of the present invention to provide a liquid crystal display device including an alignment film having high scrape resistance and a high alignment control ability, and to provide a method for fabricating the same.

A liquid crystal display device according to the present invention includes a substrate, and an alignment film. The alignment film includes a first layer on the substrate, and a second layer on the first layer. The first layer has a higher crosslinking agent concentration than that of the second layer.

The liquid crystal display device according to the present invention includes the substrate, and the alignment film. The alignment film includes the first layer on the substrate, and the second layer on the first layer. Since the first layer has a higher crosslinking agent concentration than that of the second layer, the liquid crystal display device includes the alignment film which has both higher scrape resistance and a higher alignment control ability.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view illustrating the structure of an alignment film according to a first preferred embodiment;

FIG. 2 is a cross-sectional view illustrating the structure of an alignment film in a modification example of the first preferred embodiment;

FIGS. 3 to 8 are views each illustrating a method for forming the alignment film according to the first preferred embodiment;

FIG. 9 is a plan view of a liquid crystal panel according to the first preferred embodiment;

FIG. 10 is a cross-sectional view of the liquid crystal panel according to the first preferred embodiment; and

FIG. 11 is a flow chart illustrating a process for fabricating the liquid crystal panel according to the first preferred embodiment.

### DESCRIPTION OF THE PREFERRED EMBODIMENTS

### A. First Preferred Embodiment

<A-1. The Structure>

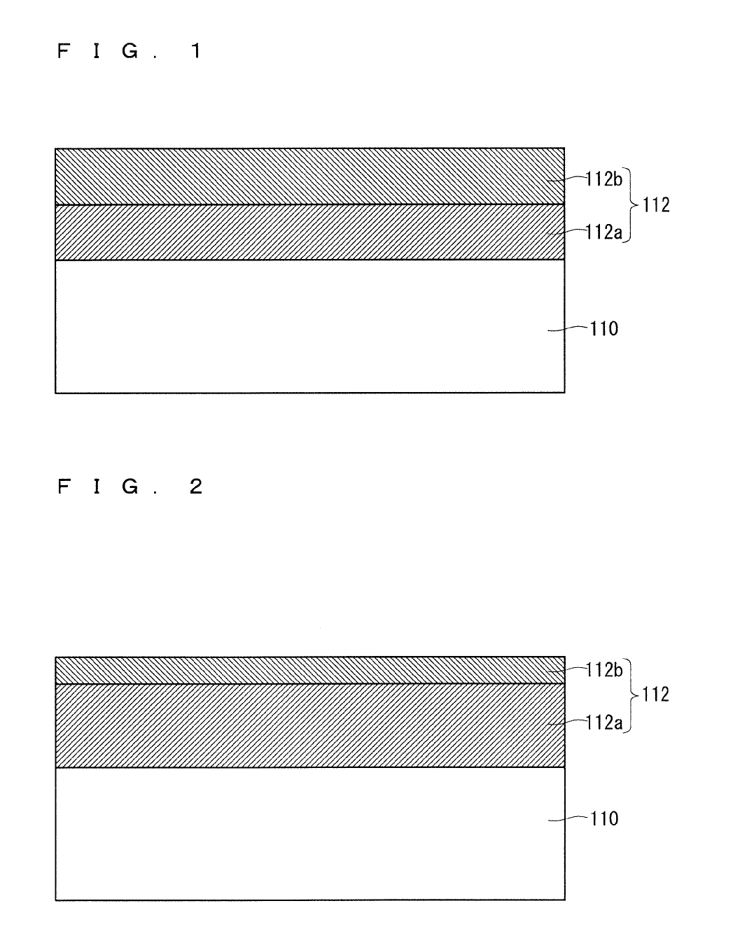

FIG. 1 is a cross-sectional view illustrating the structure of an alignment film 112 according to the first preferred embodiment. The alignment film 112 includes a first layer 112a formed on a TFT (Thin Film Transistor) array substrate 110, and a second layer 112b formed on the first layer 112a. Namely, the alignment film 112 is constituted of the first layer 112a as a lower layer, and the second layer 112b as an upper layer. The scrape resistance of the alignment film 112 is influenced mainly by the first layer 112a closer to the TFT array substrate 110, and the alignment control ability of the alignment film 112 is influenced mainly by the second layer 112b in the surface side. Therefore, by making the crosslinking-agent concentration in the first layer 112a higher than the crosslinking-agent concentration in the second layer 112b, it is possible to improve both the scrape resistance and the alignment control ability of the alignment film 112.

The material of the first layer 112a is a material formed from an ordinary liquid crystal alignment agent containing a polyimide or a polyamic acid, as a base, and an epoxy compound as a crosslinking agent, which is added thereto by about 0.02 wt %. Further, the material of the second layer 112b is a material formed from the same liquid crystal alignment agent as that in the first layer 112a, and an epoxy compound as a crosslinking agent, which is added thereto by about 0.01 wt %. Further, the solid-content concentrations in the first layer 112a and the second layer 112b are both selected within the range of 4 to 8 wt %, such that the solid-content concentrations in both the layers are substantially equal to each other, wherein the solid content in each layer is composed of the liquid crystal alignment agent and the crosslinking agent.

Although the alignment film formed on the TFT array substrate 110 has been described in this case, the same applies to the alignment film formed on the color filter substrate.

Further, in the aforementioned description, the crosslinking agent concentration in the alignment film 112 has been described as having respective fixed values in the first layer 112a and the second layer 112b. However, as a first modification example, the crosslinking agent concentration can be also continuously varied from the lower layer to the upper layer in the alignment film. For example, around the interface between the first layer 112a and the second layer 112b, the crosslinking agent concentration in the first layer 112a may be continuously decreased from the side closer to the TFT array substrate 110 to the side closer to the second layer 112b, and the crosslinking agent concentration in the second layer 112b may be continuously decreased from the side closer to the first layer 112a to the side opposite therefrom. With this structure, it is possible to suppress the occurrence of exfoliation at the interface between the first layer 112a and the second layer 112b, thereby further enhancing the scrape resistance. Further, the first layer 112a and the second layer 112b may mix with each other to some extent at the boundary portion between both the layers, which enables flexibly selecting a formation process from various processes such as a process for laminating the upper layer film on the lower layer being in an un-cured state, a process for applying only the crosslinking agent to the surface of the lower layer after the formation of the lower layer and diffusing the crosslinking agent therethrough, and a process for forming the lower layer and the upper layer while varying the amount of the cross-linking agent added thereto halfway through the formation thereof.

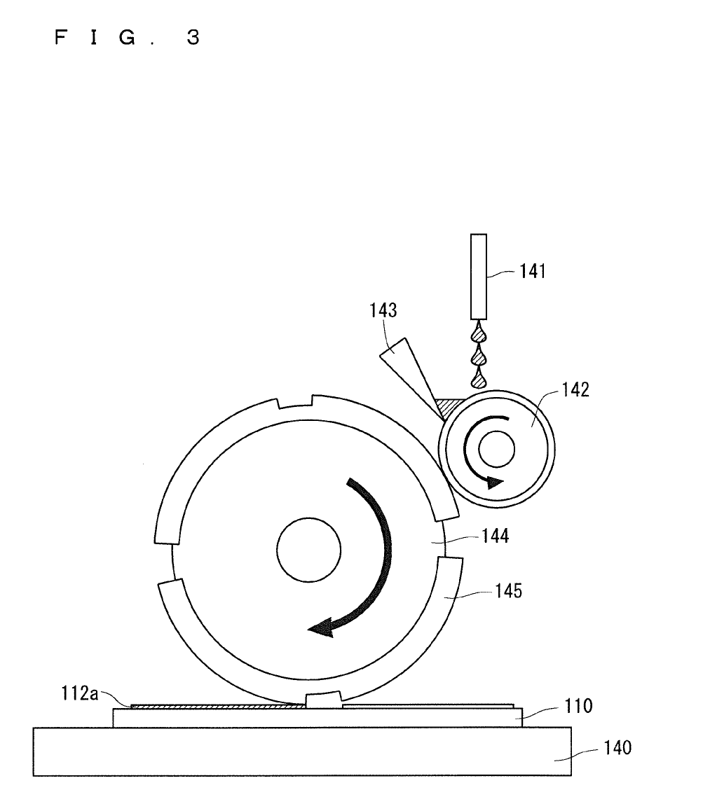

Further, in a second modification example, the alignment film may be such that the thickness of the first layer 112a is larger than the thickness of the second layer 112b, as illustrated in FIG. 2. For example, the thickness of the first layer 112a may be made to be equal to or more than 200 Å but less than 2000 Å, while the thickness of the second layer 112b may be made to be smaller compared to the first layer 112a, that is, in the range equal to or more than 5 Å but less than 400 Å. By forming the first layer 112a, which influences on the strength, such that it has a larger thickness, as described above, it is possible to enhance the scrape resistance of the alignment film.

Further, in a third modification example, in view of the same spirit as that of the second modification example, the solid-content concentration in the first layer 112a may be made to be higher than the solid-content concentration in the second layer 112b. For example, the solid-content concentration in the first layer 112a may be made to be equal to or more than 4 wt % but less than 8 wt %, while the solid-content concentration in the second layer 112b may be made to be lower compared to the first layer 112a, that is, in the range equal to or more than 2 wt % but less than 6 wt %. With this structure, it is possible to enhance the scrape resistance of the alignment film 112.

<A-2. The Process for Forming the Alignment Film>

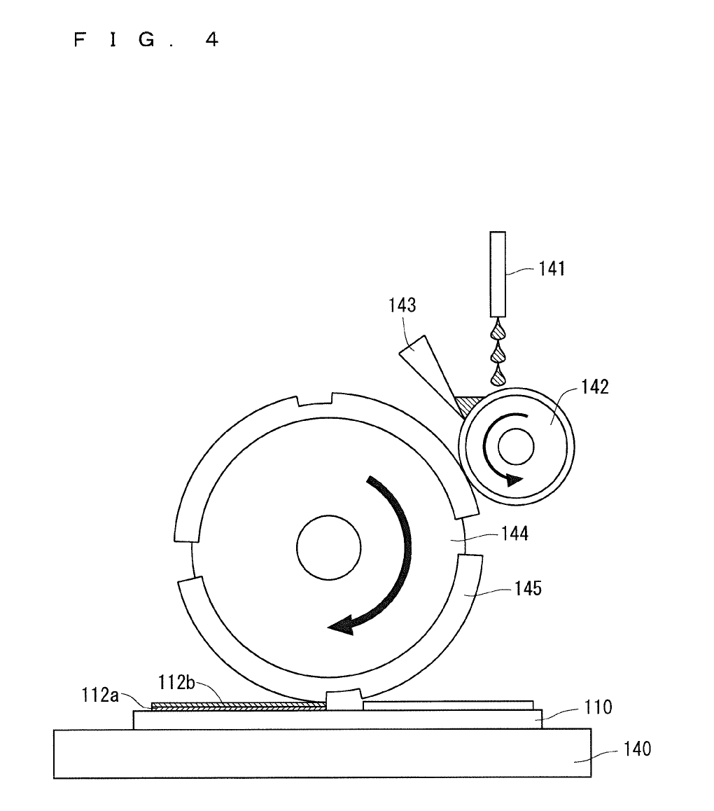

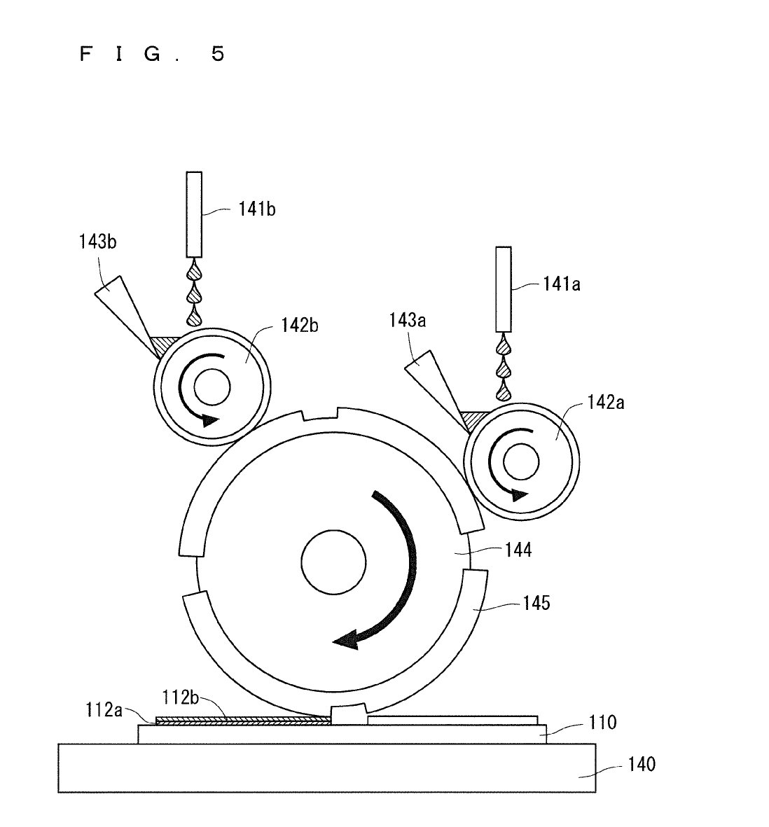

FIGS. 3 and 4 are side views illustrating a first method for forming the alignment film 112. In the first formation method, the first layer 112a of the alignment film 112 is formed on the TFT array substrate 110, using a first alignment-film transfer device (a flexo printing device) illustrated in FIG. 3 and, thereafter, the second layer 112b of the alignment film 112 is formed on the first layer 112a using a second alignment-film transfer device (a flexo printing device) illustrated in FIG. 4. By using the two alignment-film transfer devices as described above, it is possible to eliminate the necessity of a job change time after the formation of the first layer 112a before the formation of the second layer 112b, which enables successively forming the two layers.

The first and second alignment-film transfer devices each include a dispenser 141, an anilox roll 142, a doctor blade 143, a plate cylinder 144, and a transfer plate 145. The dispenser 141 drops a liquid-type alignment-material solution, into the space between the anilox roll 142 and the doctor blade 143. The doctor blade 143 scrapes off a redundant portion of the alignment material solution on the surface of the anilox roll 142, while a certain amount of the alignment material solution is transferred to the transfer plate 145 through the anilox roll 142. Further, the alignment material solution from the transfer plate 145 is applied onto the TFT array substrate 110. The alignment material solution having been applied onto the TFT array substrate 110 is heated to be cured, thereby forming the first layer 112a of the alignment film 112. Thereafter, the second layer 112b is formed on the first layer 112a, in the same way.

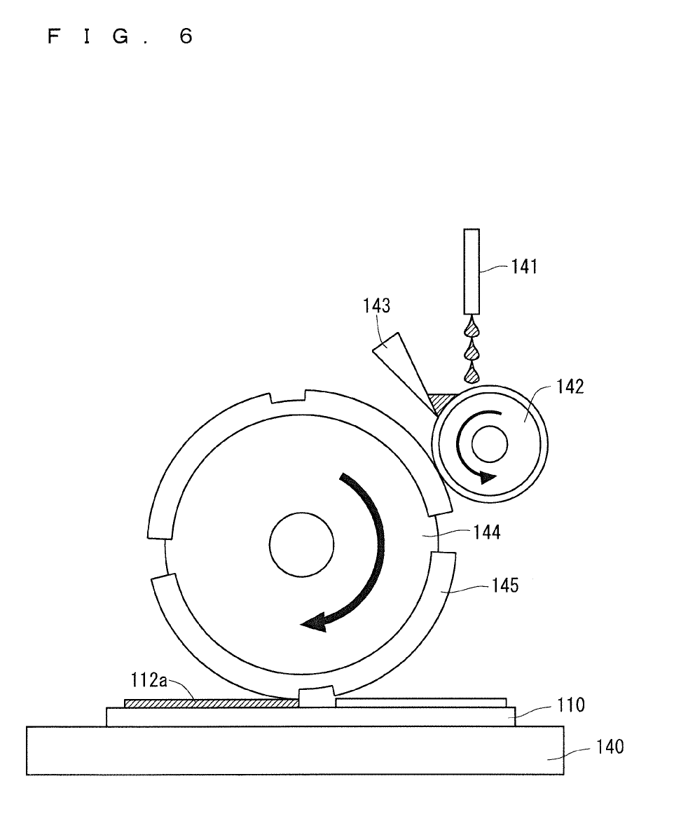

FIG. 5 is a side view illustrating a second method for forming the alignment film 112. The second formation method has a commonality with the first formation method, in that the first layer 112a and the second layer 112b are formed using a flexo printing device. However, the second formation method is different from the first formation method, in that the first layer 112a and the second layer 112b are formed using a single alignment-film transfer device (a flexo printing device) including two sets of dispensers, anilox rolls, and doctor blades.

Namely, the alignment-film transfer device for use in the second formation method includes a plate cylinder 144, two anilox rolls 142a and 142b provided around the plate cylinder 144, and doctor blades 143a and 143b and dispensers 141a and 141b provided for the respective anilox rolls 142a and 142b. Further, the first layer 112a is formed on the TFT array substrate 110 using the anilox roll 142a as a first anilox roll and, thereafter, the second layer 112b is formed on the first layer 112a using the anilox roll 142b as a second anilox roll. Accordingly, similarly to the first formation method, it is possible to eliminate the necessity of a job change time after the formation of the first layer 112a before the formation of the second layer 112b, which enables successively forming the two layers. Further, it is possible to provide the advantage that only a single alignment-film transfer device is needed.

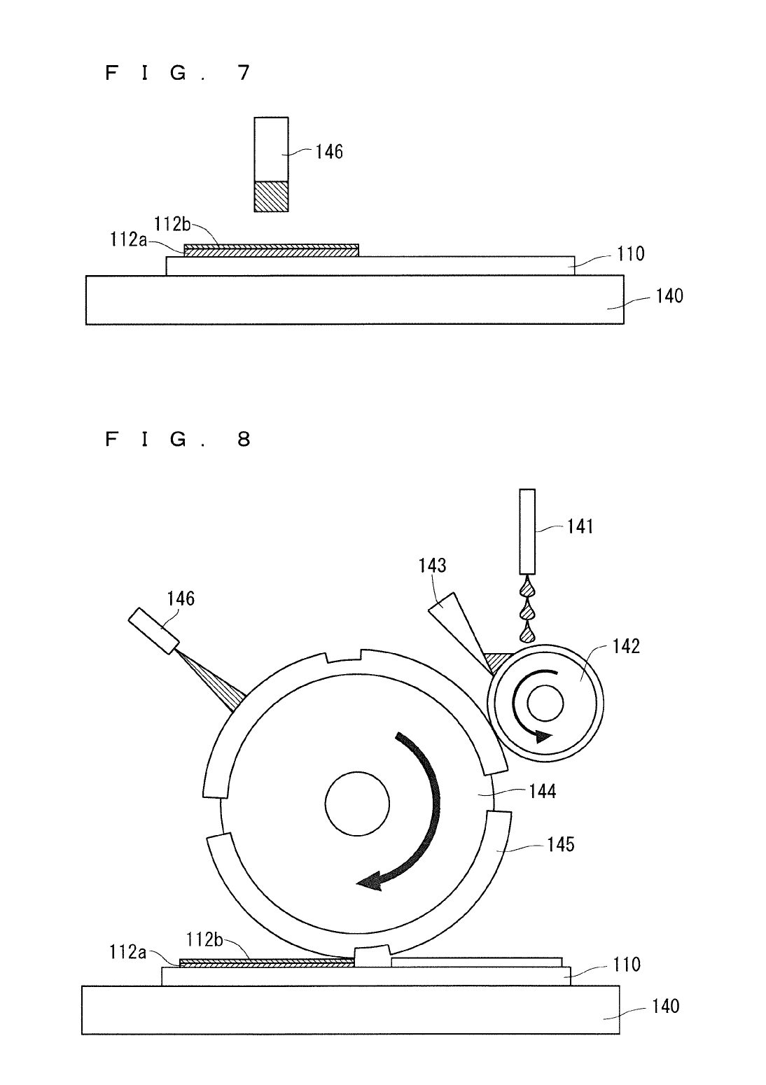

FIGS. 6 and 7 are side views illustrating a third method for forming the alignment film 112. In the third formation method, the first layer 112a is formed through the same flexo printing as that in the first and second formation methods (FIG. 6). Thereafter, as illustrated in FIG. 7, the second layer 112b is formed on the first layer 112a, through ink jet printing. Such ink jet printing has the advantage of being capable of forming the second layer 112b thinner compared to the case of flexo printing, which enables easily forming the alignment film 112 such that the second layer 112b is thinner than the first layer 112a (see FIG. 2). Further, it is possible to perform pattern coating in such a way as to slightly shrink the second layer 112b in comparison with the first layer 112a through ink jet printing, thereby suppressing fluctuations at the pattern edges being a demerit of ink jet printing.

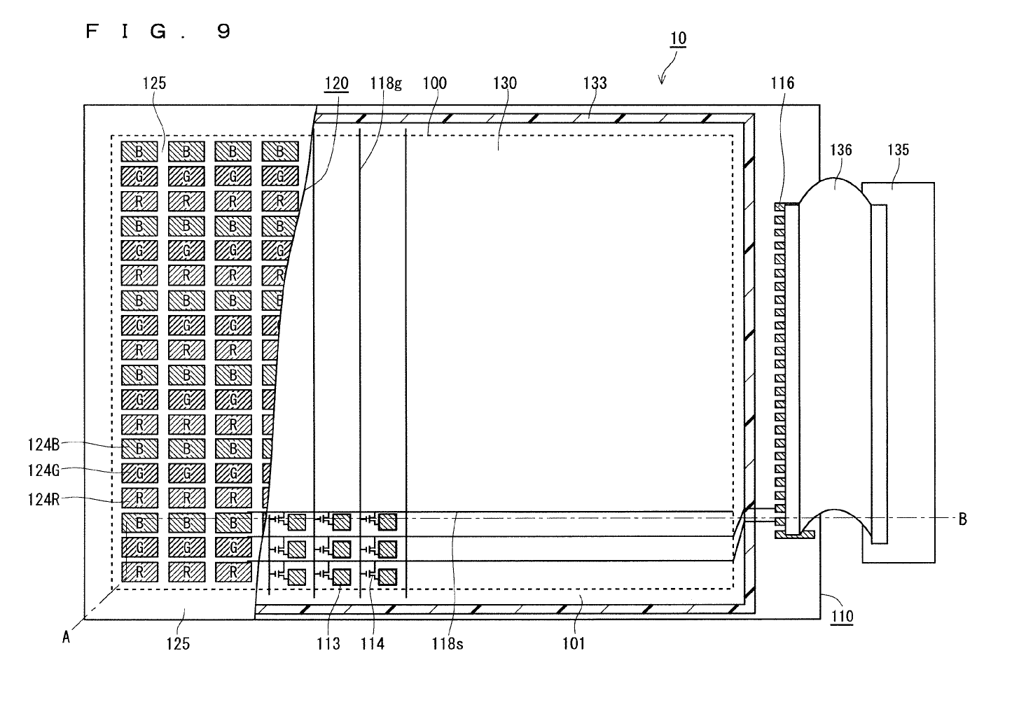

FIG. 8 is a side view illustrating a fourth method for forming the alignment film 112. In the fourth formation method, the first layer 112a is formed through the same flexo printing as that in the first and second formation methods. Thereafter, the second layer 112b is formed through spray coating. In this case, the spray coating refers to spraying and jetting an alignment material solution through a nozzle 146 to the transfer plate 145 on the plate cylinder 144 and, further, transferring the alignment material solution from the transfer plate 145 onto the first layer 112a to form the second layer 112b. With the spray coating, it is possible to form the alignment film of smaller thickness compared to the case of flexo printing, which enables easily forming the alignment film 112 such that the second layer 112b is thinner than the first layer 112a (see FIG. 2). Further, by forming the second layer 112b before a process for temporarily drying the first layer 112a, the alignment material solution in the first layer 112a is mixed with the alignment material solution in the second layer 112b, so that the alignment film 112 can be formed such that the crosslinking agent concentration is continuously decreased at the interface between the first layer 112a and the second layer 112b, from the lower layer to the upper layer.

Further, in the aforementioned first and third formation methods, similarly, by successively forming the second layer 112b without temporarily drying the first layer 112a, it is possible to mix the alignment material solution in the first layer 112a with the alignment material solution in the second layer 112b, which enables forming the alignment film 112 such that the crosslinking agent concentration is continuously decreased at the interface between the first layer 112a and the second layer 112b, from the lower layer to the upper layer. Furthermore, it is possible to form the alignment film 112 in a shorter time.

<A-3. The Liquid Crystal Display Device>

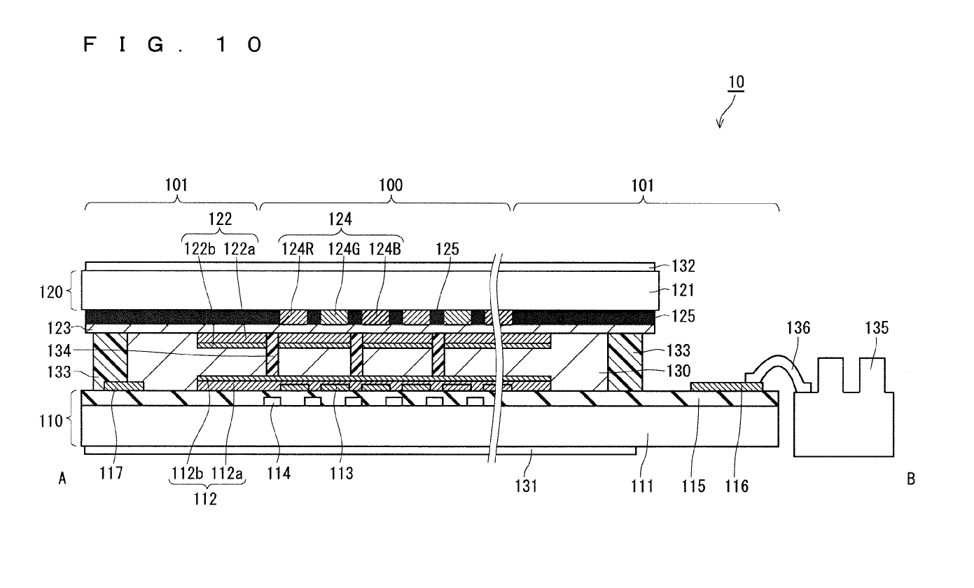

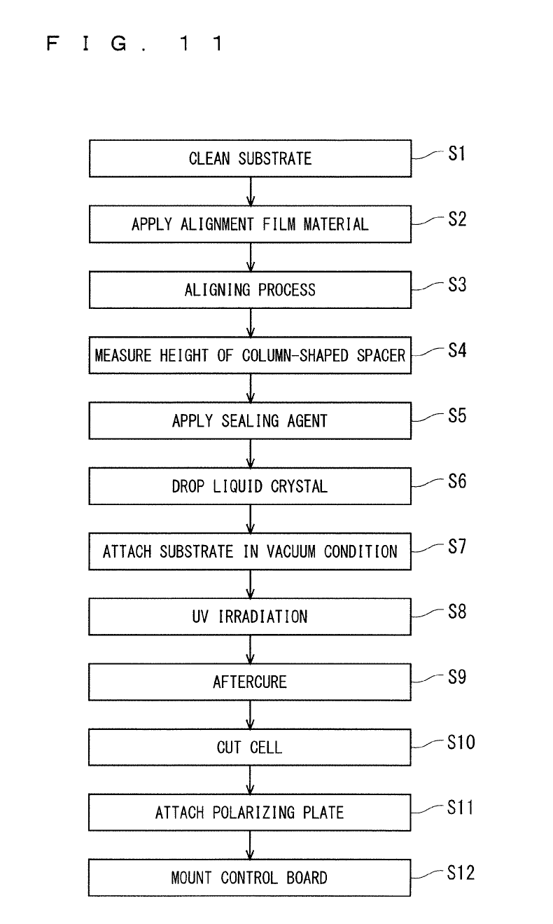

There will be described, in detail, the structure of a liquid crystal panel 10 which is a main portion of the liquid crystal display device including the alignment films according to the present invention, with reference to FIGS. 9 and 10.

FIG. 9 illustrates a plan view of the structure of an entire display panel in the structure of the liquid crystal panel 10, and FIG. 10 illustrates a cross-sectional view taken along A-B (indicated by a dashed line) in FIG. 9. Further, for preventing complicacy of the drawings, the structures other than the main portion of the present invention are eliminated or partially simplified, as appropriate. In this case, as an example, there will be described a case where the operation mode of the liquid crystal is the TN mode, and the present invention is applied to a liquid crystal panel using TFTs as switching devices.

The liquid crystal panel 10 includes a TFT array substrate 110, and a color filter (CF) substrate 120. The TFT array substrate 110 is a substrate having pixel electrodes and switching devices such as TFTs which are arranged thereon in an array shape. The CF substrate 120 is placed opposite to the TFT array substrate 110. A liquid crystal 130 is formed by a drop injection method (ODF: One Drop Filling). The drop injection method is a method for placing the liquid crystal 130 as a plurality of droplets on the substrate surface of the TFT array substrate 110 or the color filter substrate 120 and, thereafter, attaching both the substrates to each other such that a seal pattern 133 at an outer periphery is interposed therebetween, for forming the liquid crystal 130 enclosed within the area surrounded by the seal pattern 133. Accordingly, the seal pattern 133 has a closed-loop shape as illustrated in FIG. 9 and, thus, has a structural characteristic of being provided with neither an injection port as an opening portion for injecting the liquid crystal as those in liquid crystal panels fabricated by vacuum injection methods nor an additional sealing member for sealing such an injection port. Further, the material of the seal pattern 133 is a photo-curing type sealing agent (photo-curing type resin) containing conductive particles.

Further, in the plan view in FIG. 9, in order to illustrate the structure of the TFT array substrate 110 placed under the color filter substrate 120, the color filter substrate 120 is illustrated only at a portion of the left side in the figure, while the color filter substrate 120 is not illustrated in the other area, so that the structure of the TFT array substrate 110 is illustrated. In the actual structure, the color filter substrate 120 is provided up to the outside of the area surrounded by the seal pattern 133.

Further, a frame area 101 is placed in such a way as to surround the outer side of this display area 100 in a frame shape. In FIG. 9, the rectangular area which forms the display area 100 is enclosed by a dotted line, which indicates the boundary between the display area 100 and the frame area 101. Further, the display area 100 and the frame area 101 are defined on the TFT array substrate 110 and the color filter substrate 120 of the liquid crystal panel 10, and in the area sandwiched between both the substrates, and the terms “the display area 100” and “the frame area 101” are all used in the same meaning in the present specification.

Referring to FIG. 10, the TFT array substrate 110 includes a glass substrate 111, an alignment film 112, pixel electrodes 113, TFTs 114, an insulation film 115, gate wiring lines 118g, source wiring lines 118g, terminals 116, and transfer electrodes 117. The alignment film 112 is formed on a single surface of the glass substrate 111 which is a transparent substrate. A first layer 112a is formed as a lower layer (in a side closer to the glass substrate 111), and a second layer 112b is formed as an upper layer (in a side farther from the glass substrate 111). The pixel electrodes 113 are provided at a lower portion of the alignment film 112 and are adapted to apply a voltage for driving the liquid crystal thereto. The TFTs 114 are switching devices for supplying voltages to the pixel electrodes 113. The insulation film 115 covers the TFTs 114. The plurality of gate wiring lines 118g and the plurality of source wiring lines 118s are wiring lines for supplying signals to the TFTs 114. The terminals 116 receive signals to be supplied to the TFTs 114 from the outside. The transfer electrodes 117 (which are not illustrated in FIG. 9) transmit signals inputted thereto from the terminals 116 to the color filter substrate 120. Further, the TFT array substrate 110 includes peripheral wiring lines (not illustrated) for transmitting signals inputted from the terminals 116 to the gate wiring lines 118g, the source wiring lines 118s and the transfer electrodes 117, and the like.

The TFTs 114 are provided near the respective intersections of the plurality of gate wiring lines 118g and the plurality of source wiring lines 118s which are provided in such a way as to be arranged longitudinally and laterally in the display area 100 on the TFT array substrate 110. The pixel electrodes 113 are formed in such a way as to be arranged in a matrix shape, within the respective pixel areas surrounded by the gate wiring lines 118g and the source wiring lines 118s. Further, the terminals 116, the transfer electrodes 117 and the peripheral wiring lines are formed in the frame area 101. Further, a polarizing plate 131 is placed on the surface of the glass substrate 111 which is opposite from the side provided with the TFTs 114.

The color filter substrate 120 includes a glass substrate 121 which is a transparent substrate, an alignment film 122, a common electrode 123, a color filter 124, a black matrix (BM) 125, and the like. The alignment film 122 is formed on a single surface of the glass substrate 121. The alignment film 122 is structured to have a two-layer configuration similarly to that of the alignment film 112, wherein a first layer 122a is formed as a lower layer (in a side closer to the glass substrate 121), and a second layer 122b is formed as an upper layer (in a side farther from the glass substrate 121). The common electrode 123 is placed on the lower portion of the alignment film 122 and is adapted to generate an electric field between the common electrode 123 and the pixel electrodes 113 on the TFT array substrate 110 for driving the liquid crystal. The color filter 124 and the black matrix 125 are provided in the layer between the glass substrate 121 and the common electrode 123. The color filter 124 includes red filters 124R, green filters 124G and blue filters 124B corresponding to red (R), green (G) and blue (B), respectively, which are three primary colors. The black matrix 125 is a light interception layer provided for intercepting light between the red filters 124R, the green filters 124G and the blue filters 124B or for intercepting light in the frame area 101 placed outside the area corresponding to the display area 100. Further, a polarizing plate 132 is placed on the surface of the glass substrate 121 which is opposite from the side provided with the color filter 124.

The TFT array substrate 110 and the color filter substrate 120 are attached to each other with the seal pattern 133 interposed therebetween and, further, are held such that a predetermined space, namely a fixed space, is maintained between the substrates, through column-shaped spacers 134 placed in the display area 100. Further, it is also possible to employ a dual-spacer structure including a mixture of two different types of column-shaped spacer forms. In such a dual-spacer structure, for example, some of the column-shaped spacers 134 are made to have a larger height than that of the other column-shaped spacers 134. The some of the column-shaped spacers 134 are in contact with the TFT array substrate 110 and the color filter substrate 120 even in normal states and form main spacers for maintaining the space between both the substrates. The other column-shaped spacers 134 form sub spacers having a smaller height than that of the main spacers. The sub spacers are not in contact with the TFT array substrate 110 and the color filter substrate 120 in normal states and, thus, make no contribution to maintaining the space between both the substrates. However, only when the distance between both the substrates has been decreased due to external forces or the like, the sub spacers come into contact with the substrates opposed thereto, thereby maintaining the space between both the substrates.

The liquid crystal 130 is sandwiched at least in the area which is sealed by the seal pattern 133 and corresponds to the display area 100, in the space between the color filter substrate 120 and the TFT array substrate 110 held by the column-shaped spacers 134.

The transfer electrodes 117 and the common electrode 123 are electrically connected to each other through the conductive particles contained in the seal pattern 133, and signals inputted from the terminals 116 are transmitted to the common electrode 123. As the conductive particles, it is preferable to employ elastically-deformable particles in view of stability of conduction and, for example, it is preferable to employ spherical resins having surfaces plated with a metal.

Further, the liquid crystal panel 10 includes a control board 135 for generating driving signals, a FFC (Flexible Flat Cable) 136 for electrically connecting the control board 135 to the terminals 116, and the like.

The liquid crystal display device according to the present invention is structured to include a back light unit, an optical sheet, and a casing, in addition to the aforementioned liquid crystal panel 10. The back light unit is placed on the liquid crystal panel 10 in the opposite side from the display surface thereof (in the side closer to the polarizing plate 131). The back light unit forms a light source. The optical sheet is placed between the liquid crystal panel 10 and the back light unit and controls the polarization state and the directivity of the light from the back light. The liquid crystal panel 10, the back light unit, and the optical sheet are housed in the casing, in such a way as to expose the display area 100 in the color filter substrate 120.

Operations of the liquid crystal display device according to the present invention are as follows. For example, when an electric signal such as an image signal or a control signal is inputted from the control board 135 which is an external circuit, a driving voltage is applied to the pixel electrodes 113 and the common electrode 123, which changes the direction of the liquid crystal molecules depending on the driving voltage. As a result thereof, the optical transmittance of each pixel is controlled. Further, the light generated from the back light unit is passed through the TFT array substrate 110, the liquid crystal 130 and the color filter substrate 120 and, therefore, is transmitted to the outside or intercepted according to the optical transmittance of each pixel, so that a color image or the like is displayed in the display area 100 in the liquid crystal panel 10.

<A-4. The Flow for Fabricating the Liquid Crystal Display Device>

Hereinafter, with reference to a flow chart in FIG. 11, there will be described a process for fabricating the liquid crystal display device including the alignment films according to the present invention. Note that, in general, the liquid crystal panel which forms a main portion of the liquid crystal display device is fabricated by cutting a mother substrate with a larger size than that of final shapes, into one or a plurality of (multiple) liquid crystal panels. The processes in steps S1 to S9 and up to a halfway point in step S10 in FIG. 11 are processes in the state of this mother substrate.

At first, the TFT array substrate 110 and the color filter substrate 120 are prepared. The methods for fabricating the TFT array substrate 110 and the color filter substrate 120 may be common methods and, therefore, will be described briefly. The TFT array substrate 110 is fabricated by forming the TFTs 114, the pixel electrodes 113, the terminals 116 and the transfer electrodes 117 on a single surface of the glass substrate 111, by repeatedly using pattern formation processes such as film deposition, patterning through photolithography, or etching. Similarly, the color filter substrate 120 is fabricated by forming the color filter 124, the black matrix 125, the common electrode 123, and the column-shaped spacers 134 formed through patterning on an organic resin film, on a single surface of the glass substrate 121. In particular, in the case of forming the column-shaped spacers 134 such that they have a dual-spacer structure including a mixture of two different types of column-shaped spacer forms, it is preferable to differently from the column-shaped spacers such that they are different from each other only in height, using a halftone technique, which is a well-known dual-spacer structure forming method.

Subsequently, the TFT array substrate 110 having the pixel electrodes 113 formed thereon is cleaned (step S1).

Next, an alignment film material is applied thereto (step S2). More specifically, a two-layer alignment film material is applied and formed on a single surface of the TFT array substrate 110. The concrete method for applying the two-layer alignment film material thereto is as described in <A-2> and, therefore, is not described here in detail. Subsequently, the two-layer alignment film material applied and formed is subjected to a firing process to be dried, using a hot plate and the like.

Further, regarding the drying process, a selection should be made so as to be appropriate for the alignment film according to the first preferred embodiment or the respective alignment films according to the modification examples, as to whether or not temporary drying or a main drying process for the first layer should be performed halfway through the application of the two-layer alignment film, namely after the application of the first layer but before the application of the second layer.

Thereafter, an aligning process is performed (step S3) on the alignment film material applied and formed to have the two layers in the step S2, so that the alignment film 112 is formed. An aligning process such as a rubbing process for forming fine grooves and flaws in certain directions in the surface of the alignment film material is performed thereon. Further, in this case, the aligning process is not limited to such a rubbing process, and it is also possible to select a well-known aligning process method, such as an optical aligning process. However, in consideration of the fact that the alignment film 112 according to the present invention has excellent scrape resistance, particularly, it is possible to make the effects of the present invention more prominent by employing a rubbing process which applies a relatively larger pressure to the alignment film surface during the aligning process.

Although, in the aforementioned description, the steps S1, S2 and S3 have been described as being processes for the TFT array substrate 110, the same applies to the color filter substrate 120 having the common electrode 123 formed thereon. Namely, for the color filter substrate 120, similarly, the substrate cleaning process (the step S1) is performed and, thereafter, a two-layer alignment film material is applied thereto (the step S2). Further, a rubbing process as the aligning process (the step S3) is performed thereon to form the alignment film 122. Further, in forming the alignment film 122 on the color filter substrate 120, actually, the alignment film 122 is overlaid on the column-shaped spacers 134 formed on the color filter substrate 120. However, since the alignment film 122 has a relatively smaller thickness with respect to the height of the column-shaped spacers 134, the alignment film applied onto the column-shaped spacers 134 is not illustrated in FIG. 10.

Next, the height of the column-shaped spacers 134 is measured (step S4). Since the column-shaped spacers 134 are formed on the color filter substrate 120, the initial height of the column-shaped spacers 134 is measured on the color filter substrate 120. Note that the reason for measuring the height of the column-shaped spacers 134 in this process is that the amount of the liquid crystal 130 to be dropped thereon is to be determined for injecting the liquid crystal 130 through a drop injection (ODF) method, which will be described again later. Accordingly, the height of the column-shaped spacers 134 (the height of the main spacers in the case of a dual-spacer structure) is measured, which defines the cell gap relating to the volume of the vacancy to be filled with the liquid crystal 130.

Thereafter, a sealing agent is applied to the main surface of the TFT array substrate 110 or the color filter substrate 120 to form the seal pattern 133 (step S5). In this case, the sealing agent, as a printing paste, is applied thereto in such a way as to surround the display area 100 in the liquid crystal panel 10, using a screen printing device.

Next, the liquid crystal 130 is dropped onto the substrate on which the seal pattern 133 has been formed in the step S5, within the area surrounded by the seal pattern 133 (step S6). The amount of the liquid crystal 130 to be dropped thereon is determined based on the height of the column-shaped spacers 134 which has been measured in the step S4.

Thereafter, the TFT array substrate 110 and the color filter substrate 120 in the mother substrate state are attached to each other in a vacuum condition (step S7), thereby forming a mother cell substrate.

Next, the mother cell substrate is irradiated with an ultraviolet (UV) ray (step S8) to temporarily cure the seal pattern 133. Further, the mother cell substrate is heated to perform aftercure (step S9), thereby completely curing the seal pattern 133.

Next, the mother cell substrate is cut along scribe lines to be separated into individual liquid crystal panels 10 (step S10).

For the individual liquid crystal panels 10 obtained by the aforementioned cutting, a process for attaching the polarizing plates 131 and 132 thereto (step S11), and a process for mounting the control board 135 therein (step S12) are performed. Thus, the fabrication of the liquid crystal panel 10 is completed.

Further, the back light unit is placed on the back surface of the TFT array substrate 110 which forms an invisible side of the liquid crystal panel 10, with an optical film such as a phase difference plate interposed therebetween. Further, the liquid crystal panel 10 and these peripheral members are housed as appropriate within the casing made of a resin or a metal. Thus, the fabrication of the liquid crystal display device is completed.

Further, although, in <A-3> and <A-4>, the description has been given by exemplifying a liquid crystal display device using a liquid crystal panel of the TN mode, it is also possible to apply the alignment film according to the present invention to liquid crystal display devices employing liquid crystal panels of other operation modes. In particular, by applying the structure of the alignment film according to the present invention to liquid crystal display devices employing liquid crystal panels of FFS types, which are required to include alignment films with more-highly-enhanced scrape resistance and a more-highly-enhanced alignment control ability, it is possible to make the effects of the present invention more prominent.

<A-5. Effects>

The liquid crystal display device according to the first preferred embodiment of the present invention includes the substrates (the TFT array substrate 110 and the CF substrate 120), and the alignment films 112 and 122 on the substrates. Further, the alignment film 112, 122 includes the first layer 112a, 122a on the substrate, and the second layer 112b, 122b on the first layer 112a, 122a, wherein the first layer 112a, 122a has a higher crosslinking agent concentration than that of the second layer 112b, 122b. Accordingly, it is possible to enhance both the scrape resistance and the alignment control ability of the alignment film 112, thereby suppressing bright spot defects and AC burn-in characteristics.

Further, in the first layer 112a, 122a, around the interface between the first layer 112a, 122a and the second layer 112b, 122b, the crosslinking agent concentration is continuously decreased from a side closer to the substrate toward a side closer to the second layer 112b, 122b. In the second layer 112b, 122b, around the interface between the second layer 112b, 122b and the first layer 112a, 122a, the crosslinking agent concentration is continuously decreased from a side closer to the first layer 112a, 122a toward the opposite side. With this structure, it is possible to suppress exfoliation at the interface between the first layer 112a and the second layer 112b, thereby further enhancing the scrape resistance of the alignment film 112.

Further, the first layer 112a, 122a, which influences the strength, can be made thicker than the second layer 112b, 122b, which can enhance the scrape resistance of the alignment film 112.

Further, the solid-content concentration in the second layer 112b, 122b can be made lower than the solid-content concentration in the first layer 112a, 122a, which can enhance the scrape resistance of the alignment film 112.

Further, the method for fabricating the liquid crystal display device according to the first preferred embodiment of the present invention includes (a) a step of forming the first layer 112a, 122a in the alignment film 112, 122 on the substrate, and (b) a step of forming the second layer 112b, 122b in the alignment film on the first layer 112a, 122a. Since the alignment film 112 has both higher scrape resistance and a higher alignment control ability, thereby suppressing bright spot defects and AC burn-in characteristics.

Further, in the step (a), the first layer 112a, 122a is formed using the first flexo printing device, and in the step (b), the second layer 112b, 122b is formed using the second flexo printing device, which eliminates the necessity of a job change time after the formation of the first layer 112a, 122a but before the formation of the second layer 112b, 122b, thereby enabling successively forming the two layers.

Also, the alignment film 122 is formed using the flexo printing device including the plate cylinder 144, the anilox roll 142a and the anilox roll 142b provided around the plate cylinder 144. Further, in the step (a), the first layer 112a, 122a is formed using the anilox roll 142a (the first anilox roll) and, in the step (b), the second layer 112b, 122b is formed using the anilox roll 142b (the second anilox roll). This eliminates the necessity of a job change time after the formation of the first layer 112a, 122a but before the formation of the second layer 112b, 122b, thereby enabling successively forming the two layers.

Also, in the step (a), the first layer 112a, 122a is formed through flexo printing, and in the step (b), the second layer 112b, 122b is formed through ink jet printing. With this method, the second layer 112b, 122b can be formed to have a smaller thickness, which enables easily forming the alignment film 112 such that the second layer 112b, 122b is thinner than the first layer 112a, 122a. Further, it is possible to perform pattern coating in such a way as to slightly shrink the second layer in comparison with the first layer 112a through the ink jet printing, thereby suppressing fluctuations at the pattern edges being a demerit of ink jet printing.

Also, in the step (a), the first layer 112a, 122a may be formed through flexo printing, and in the step (b), the second layer 112b, 122b may be formed through spray coating. With the spray coating, it is possible to form the alignment film such that it has a smaller thickness, which enables easily forming the alignment film 112 such that the second layer 112b, 122b is thinner than the first layer 112a, 122a.

Further, the second layer 112b, 122b may be formed before drying the first layer 112a, 122b having been formed, which can cause the alignment material solution in the first layer 112a, 122a to mix with the alignment material solution in the second layer 112b, 122b, thereby enabling forming the alignment film 112 such that the crosslinking agent concentration is continuously decreased around the interface between the first layer 112a, 122a and the second layer 112b, 122b, from the lower layer to the upper layer.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display device comprising:
a substrate; and
an alignment film on said substrate;
wherein said alignment film includes
a first layer on said substrate, and
a second layer on said first layer, and
said first layer has a higher crosslinking agent concentration than that of said second layer.

2. The liquid crystal display device according to claim 1, wherein
in said first layer, around an interface between said first layer and said second layer, said crosslinking agent concentration is continuously decreased from a side closer to said substrate toward a side closer to said second layer and, in said second layer, around an interface between said second layer and said first layer, said crosslinking agent concentration is continuously decreased from a side closer to said first layer toward an opposite side.

3. The liquid crystal display device according to claim 1, wherein
said first layer is thicker than said second layer.

4. The liquid crystal display device according to claim 1, wherein a solid-content concentration in said second layer is lower than a solid-content concentration in said first layer.

5. A method for fabricating the liquid crystal display device according to claim 1, the method comprising:
(a) a step of forming said first layer in said alignment film on said substrate; and
(b) a step of forming said second layer in said alignment film on said first layer.

6. The method for fabricating the liquid crystal display device according to claim 5, wherein
said step (a) comprises a step of forming said first layer using a first flexo printing device, and
said step (b) comprises a step of forming said second layer using a second flexo printing device.

7. The method for fabricating the liquid crystal display device according to claim 5 through formation of said alignment film with use of a flexo printing device, wherein
said flexo printing device includes
a plate cylinder, and
a first anilox roll and a second anilox roll which are provided around said plate cylinder, and
said step (a) comprises a step of forming said first layer using said first anilox roll, and
said step (b) comprises a step of forming said second layer using said second anilox roll.

8. The method for fabricating the liquid crystal display device according to claim 5, wherein
said step (a) comprises a step of forming said first layer through flexo printing, and
said step (b) comprises a step of forming said second layer through ink jet printing.

9. The method for fabricating the liquid crystal display device according to claim 5, wherein
said step (a) comprises a step of forming said first layer through flexo printing, and
said step (b) comprises a step of forming said second layer through spray coating.

10. A method for fabricating the liquid crystal display device according to claim 2 through formation of said alignment film with use of a flexo printing device, the method comprising:
(a) a step of forming said first layer in said alignment film on said substrate; and
(b) a step of forming said second layer in said alignment film on said first layer, wherein
said flexo printing device includes
a plate cylinder, and
a first anilox roll and a second anilox roll which are provided around said plate cylinder, and
said step (a) comprises a step of forming said first layer using said first anilox roll, and
said step (b) comprises a step of forming said second layer using said second anilox roll before drying said first layer formed in said step (a).
